(19) United States
(12) Patent Application Publication
(10) Pub. No.: US 2020/0272729 A1
(43) Pub. Date: Aug. 27, 2020

(54) Quantum Secure Password Application

(71) Applicant: Paul Regen, Felton, CA (US)

(72) Inventor: Paul Regen, Felton, CA (US)

(21) Appl. No.: 16/162,184

(22) Filed: Oct. 16, 2018

Related U.S. Application Data
(63) Continuation-in-part of application No. 16/028,372, filed on Jul. 5, 2018, now abandoned.

(51) Int. Cl. G06F 21/46

(52) U.S. Cl. CPC G06F 21/46; G06F 21/604

(57) ABSTRACT

A hacking prevention scheme is taught using a temporal or time delay element when implementing the use of a password where the delay can be introduced using a plurality of means including but not limited to the holding down of certain keys for a certain amount of time before, during or after the entry of a password. In one embodiment a user introduces a time delay between the entry of the characters of a password. Methods are also taught for temporal element introduction for smartphones and mobile devices.

### CROSS REFERENCE TO RELATED APPLICATIONS

The present U.S. non-provisional patent application does hereby claim priority to U.S. non-provisional patent application Ser. No. 16/028,372, filed on Jul. 5, 2018 which claims priority to U.S. provisional application Ser. No. 62/579,031 filed on Oct. 30, 2017. The entire disclosures of both applications listed above are included herein in their entirety at east by reference

### BACKGROUND OF THE INVENTION

### 1. Field of the Invention

The present invention is in the technical field of Personal Data Security. More particularly, the present invention is in the technical field of creating a more secure password technology.

### 2. Discussion of the State of the Art

It has been said that the first computer passwords where used in the mid 1960s from MIT's Compatible Time-Sharing System (CTSS). Historically the time needed to crack a password has been proportional to the length of the password. It is for this reason why password users are encouraged to use long complex passwords.

To solve this problem the invention introduces a temporal element to the user's password to prevent highly advanced quantum computers from running algorithms to test billions or even trillions of combinations within seconds. Today's password technology has proven to be inadequate due to the development of modern high performance computers that are available to the general consumer. The result has left the general population of password users highly exposed and vulnerable to being hacked by owners of password cracking software. With millions and potentially billions of people using passwords to protect their highly sensitive data the need to solve this problem has become highly apparent to the inventor. As one deeply involved in mobile financial product development, the inventor felt a compelling desire to improve the security of all products providing data access.

What is clearly needed is an invention that solves these problems by introducing a temporal element to the user's password to not only add complexity to the password, but also increase the time needed to implement password hacking protocols from seconds to years, thus making it virtually impossible to crack/hack into computer held data.

### SUMMARY OF THE INVENTION

What is disclosed in this invention is a method and apparatus for inserting a temporal element into a password to prevent circumvention of that password by unauthorized users.

In one embodiment a temporal element (time sensitive) is introduced into a user's password during password selection.

In one embodiment a temporal element (time sensitive) is introduced into a user's password during password selection between the characters of a password whether they are alphanumeric, special symbols or function keys of a keyboard.

In one embodiment a user selects a password using one or more alphanumeric characters, special characters and/or symbols, inserts a temporal element between a least two of the characters of a password and the temporal element becomes part of the user's password in the future so that the user will have to invoke the temporal element in the password when reentering the password whether on a web browser, a web site, an operating system or a program or any other instance where a password is required to release data or open a physical lock or gate.

In one embodiment a user selects a password using one or more alphanumeric characters, special characters and/or symbols, inserts one or more temporal elements between at least two of the characters of a password and the temporal elements become a part of the user's password in the future. In one embodiment the temporal element is 0.5 seconds.

In one embodiment the temporal element is invoked by holding down at least one key on a keyboard. In another embodiment the temporal element is invoked by holding down 2 keys of a keyboard at the same time.

In another embodiment a temporal element is inserted between at least 2 of the characters of a password. Again the user may choose a 0.5 second delay between at least 2 characters thereby securing the temporal element into the password.

In one embodiment the keys are held down for the specified amount of time the password releases data and wherein if the keys are not held down for long enough the password does not function to release data or open locks gates etc . . .

In one embodiment a notification element alerts a user that one or more temporal elements of a password have been reached when entering a password that has temporal elements required to release data. In one embodiment the alert element is a light on a keyboard, an audio alert, a visual alert or a physical alert such as a vibration of a part of a users computing system. In another embodiment the alert is any type of haptic feedback generated by a computer, smartphone, text or any computer peripheral. In one embodiment a notification element message is pushed to a smart phone alerting the user that the temporal element has been reached while entering a password containing a temporal element. In one embodiment an alert notification element message is pushed to a smart phone alerting the user that the temporal element has been reached while entering a password containing a temporal element. In one embodiment a progress bar may be used to see the progress of a temporal element while being entered.

In one embodiment the temporal element is created by a time sensitive touch element on a touch screen.

In another embodiment the touch element is created by dragging ones finger in a certain direction for a certain amount of time on a touch sensitive screen while entering a password thereby creating a temporal element into the password.

In another embodiment the touch element is created by dragging ones finger in a squiggle pattern for a certain amount of time on a touch screen while entering a password thereby creating a temporal element into a password.

### BRIEF DESCRIPTION OF THE DRAWINGS

FIG. 1 is table showing the time impact with various code sizes using a super computer on a conventional password.

FIG. 2 is table showing the time impact with various code sizes using a super computer and a temporal password.

FIG. 3 shows how a typical temporal code could be implemented using a computer keyboard with function keys.

FIG. 4 shows how a typical temporal code could be implemented using a keyboard on a mobile device without function keys.

FIG. 5 shows a locked screen to mobile computing device such as smartphone, a smart credit card or some other mobile computing device.

FIG. 6 is an illustration of a time delay entry method according to one embodiment of the present invention.

FIG. 7 is an illustration of a time delay entry method according to one embodiment of the present invention.

FIG. 8 is an illustration of a time delay entry method according to one embodiment of the present invention.

FIG. 9 is an illustration of a time delay entry method according to one embodiment of the present invention.

### DETAILED DESCRIPTION OF THE INVENTION

As computers continue to increase in power/speed measured in Floating Point Operations per Second (FLOPS) the time to decode passwords has become faster and easier. To put this concept into perspective, there has been a 1 trillion-fold increase in computer performance over the past 60 years. As of 2017 computers are now capable of performing nearly one hundred quadrillion FLOPS.

In cryptography, a brute-force attack consists of an attacker submitting many passwords or passphrases with the hope of eventually guessing correctly. The attacker systematically checks all possible passwords and passphrases until the correct one is found. When password-guessing, this method is very fast when used to check all short passwords, but for longer passwords other methods such as the dictionary attack are used because a brute-force search takes too long. Longer passwords, passphrases and keys have more possible values, making them exponentially more difficult to crack than shorter ones.

The insertion of a time delay in a password renders that password exponentially more difficult to crack using brute force methods. As an electrical engineer working in the Financial Technology industry it has become very apparent that a solution to this increasing problem must be addressed and solved

A temporal password uses a time element during the creation and implementation of the password. For example, a password code with only 5 characters using the full alphanumeric character set with just one temporal 0.5 second letter would have the effect of taking a maximum of 15 years to go through the entire set of possible codes regardless of the power of the computer used to hack the code. If the user creates an 8 character password using the same alphanumeric code with the same 0.5 second delay, the time element is increased to over two thousand years to go through an entire set of possible codes again regardless of the power of the computer.

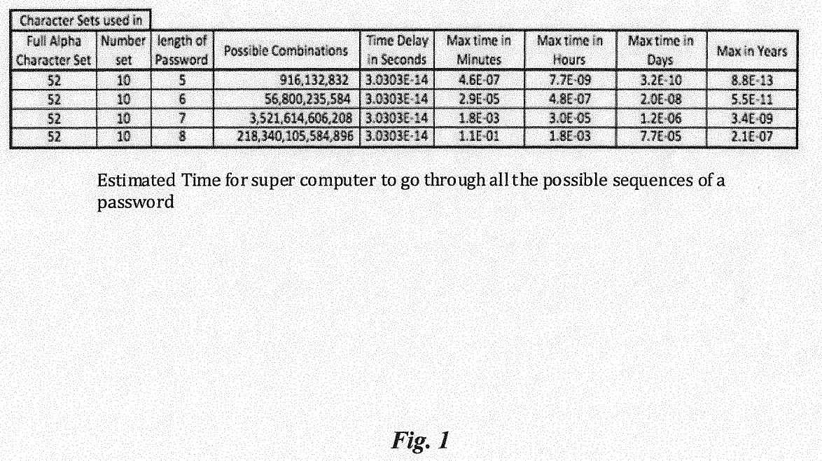

FIG. 1 is a table showing a conventional password and how quickly a super computer can produce all the possible password sequences based on a full alphanumeric password of various lengths without the implementation of a temporal password element.

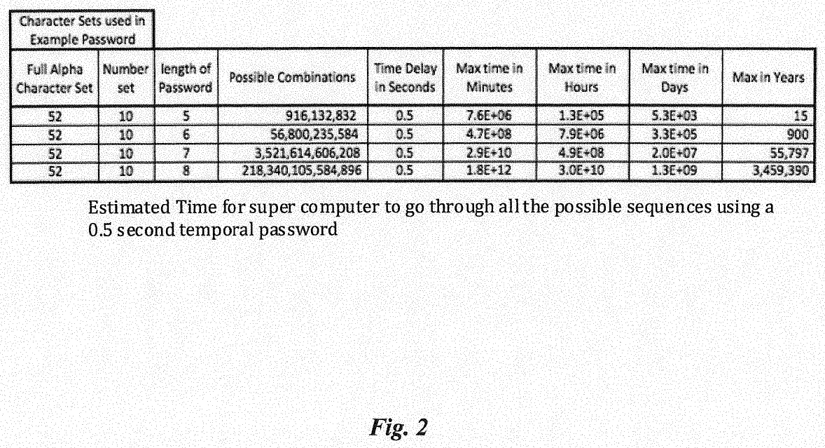

In FIG. 2 is the same table as FIG. 1 with the exception of only one temporal delay being added to the password. In one embodiment multiple temporal delays may be added to a password to make it even more difficult for a hacker to break the code if the password creator chooses to. In another embodiment a temporal element may be added either before the password is entered or after the password is entered but before the enter key or other indicia (login button) is clicked (on a web site for example) indicating the password has been entered and ready to proceed to data protected by said password. In another embodiment a temporal element may be added as a wait time between entering characters of a password. In another embodiment a double temporal element is introduced into a password by holding each character of the password down for a certain amount of time while entering the password in addition to waiting a certain amount of time before entering each character so that 2 types of temporal elements are in use at the same time.

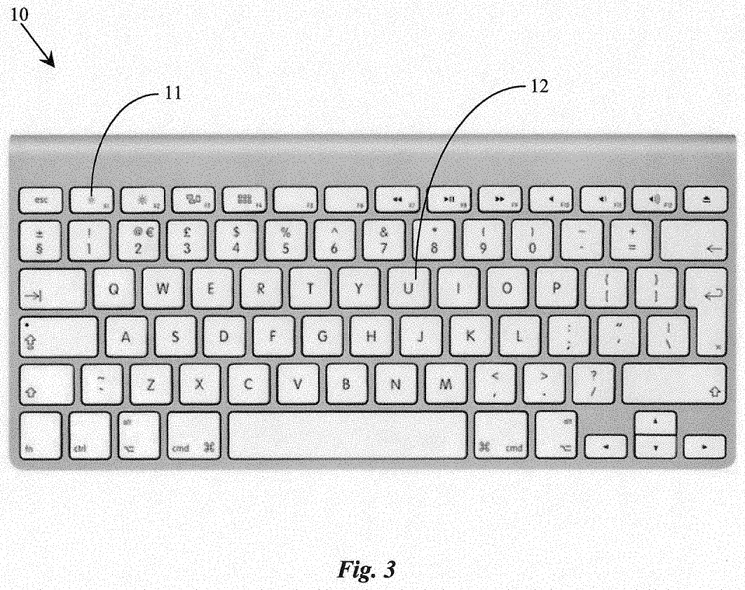

In FIG. 3 is a conventional keyboard, element 10, with function keys F1-F12. In this example a function key F1 (element 11) is used to create a temporal delay. To implement the temporal delay all the password user would have to do is press a pre-defined function key such as F1 and simultaneously press any character key, in this example the “U” key (element 12) is pressed down and held down for approximately 0.5 seconds (½ Second) or more to create the temporal delay. When both keys F1 (element 11) and the “U” (element 12) are released the temporal delay is recorded and becomes an integral part of the password. When re-entering the password to unlock the data the user simply enters the password as they entered it previously using the F1 function key and U key holding them down the appropriate amount of time to release the data. Any previously defined key spelled out in the instruction manual will also function as well. Note: holding the key down greater than the 0.5 seconds or any other specified time delay will still have the effect of unlocking the data. In one embodiment a temporal is invoked by holding down one or more keys on a keyboard in a sequence wherein each key independently invokes a temporal element into a password.

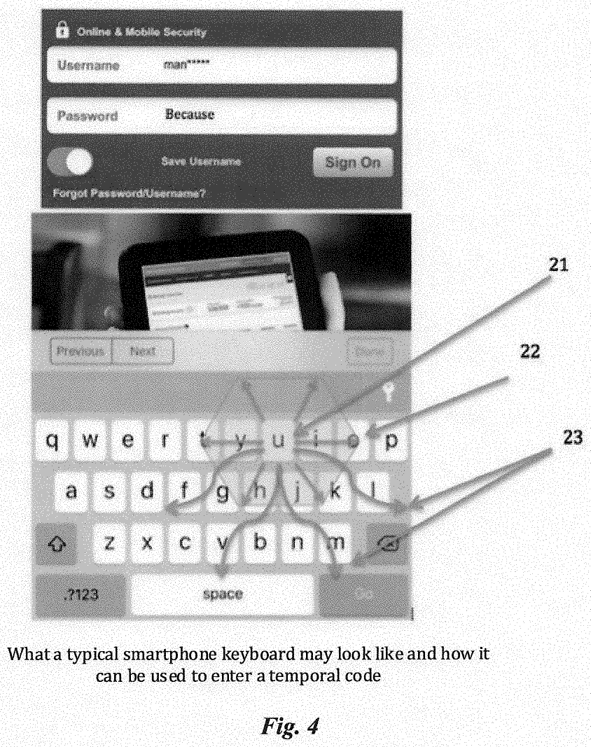

FIG. 4 shows a typical smartphone keyboard (element 20) using an online banking login application. The drawing in FIG. 4 also shows how by pressing on any key, in this example the “U” key (element 21), then the user sliding their finger in a particular direction over a period of time such as 0.5 seconds, can be the manner in which the temporal code is entered into a password.

Making the sliding gesture time sensitive and directionally sensitive on a touch sensitive display (element 22) or adding a directional squiggle (element 23) are other ways to make the temporal password even more novel and complex and thus more challenging for it to be decoded/hacked.

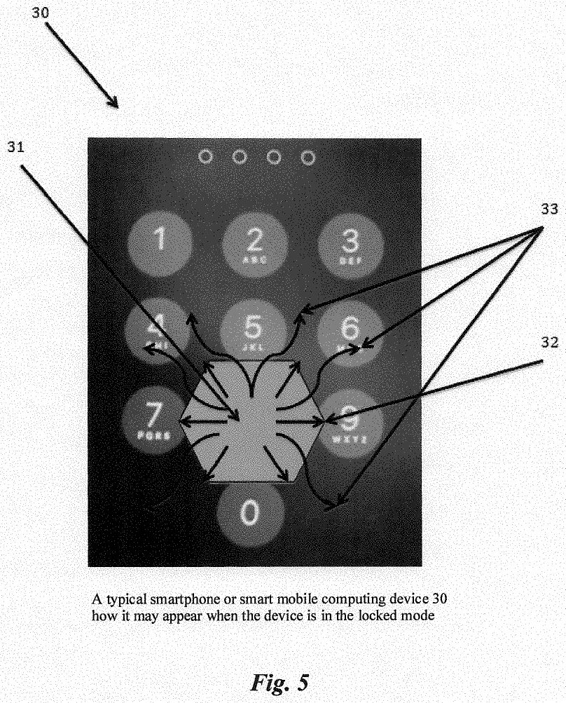

FIG. 5 shows a typical smartphone or smart mobile computing device (element 30) how it may appear when the device is in the locked mode. The drawing in FIG. 5 also shows how by pressing on any key, in this example the “8” key (element 31), then by sliding your finger in a particular direction over a period of time such as 0.5 seconds or greater, can be the manner in which the temporal delay is entered into the password.

Again by making it directionally sensitive (element 32) or adding a directional squiggle (element 33) during the entry phase of the password is another way to make the temporal password even more complex thus more challenging for it to be decoded/hacked.

This time sensitive password can be implemented in an app on a smart device like a smart phone or can be built into the operating system. In one embodiment this technology is implemented as an add-on to existing applications such as Microsoft word or apple pages. The technology may also be implemented as part of a web browser or a browser extension so that a temporal element may be introduced into passwords on a user's web page(s) such as a banking login page or any other web page that necessitates a user to enter a password.

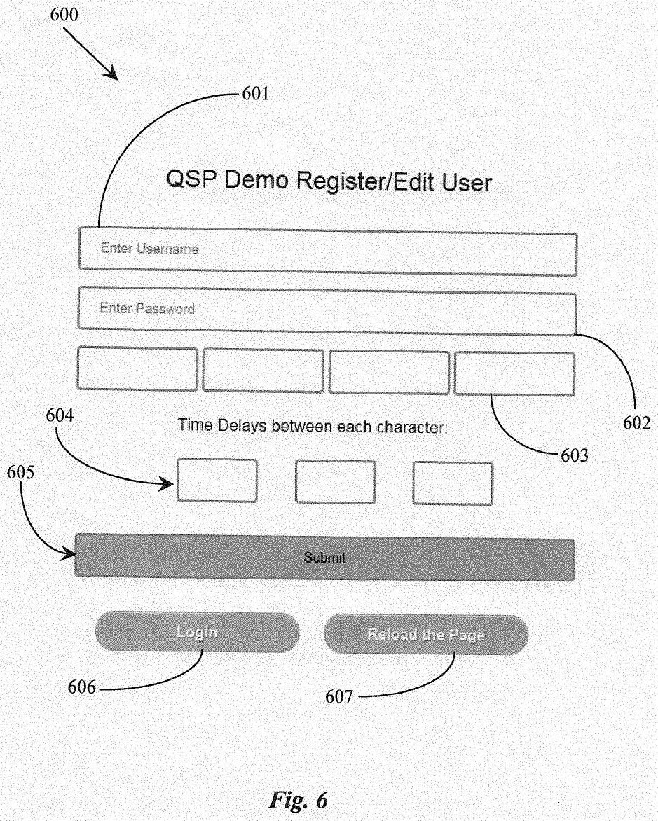

FIG. 6 illustrates an embodiment of the present invention that implements a time delay between the characters of a password instead of holding a key or keys down or holding one key with a finger on a touch screen and sliding the other as a means of entering a time delay. FIG. 6 includes a temporal time delay password creation demo including elements 601 username, element 602 password, element 603, showing the password as it is being entered, element 604 indicating time delays between the entry of each character of a password, element 605 the submit button, element 606 the login button and element 607 the reload page button.

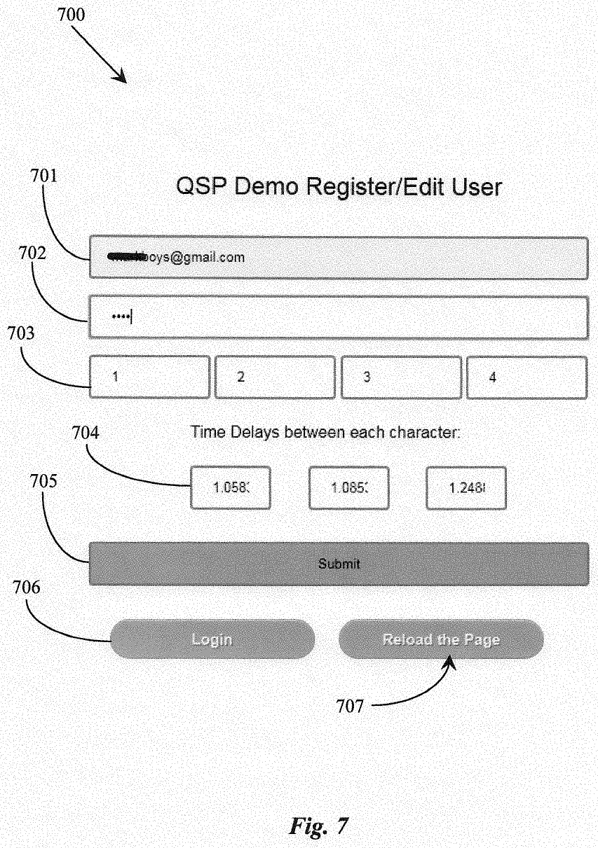

FIG. 7 shows a portion of the operation of creating a password with time delays created in between entering characters of a password. A user would first enter their email address or other indicia as a username in box 701. The user would then enter, in this case a 4 character password, introducing one or more time delays between entering the characters of the password. Those password characters would be shown in the four boxes element 703 as the password is being entered by the user. The time delays the user has entered between characters are shown in three boxes 704. The user may practice entering time delays until they are comfortable with the time delays entered. Once the user is ok with the time delays entered he may click the submit button 705 which saves the password chosen including the time delays between one or more characters.

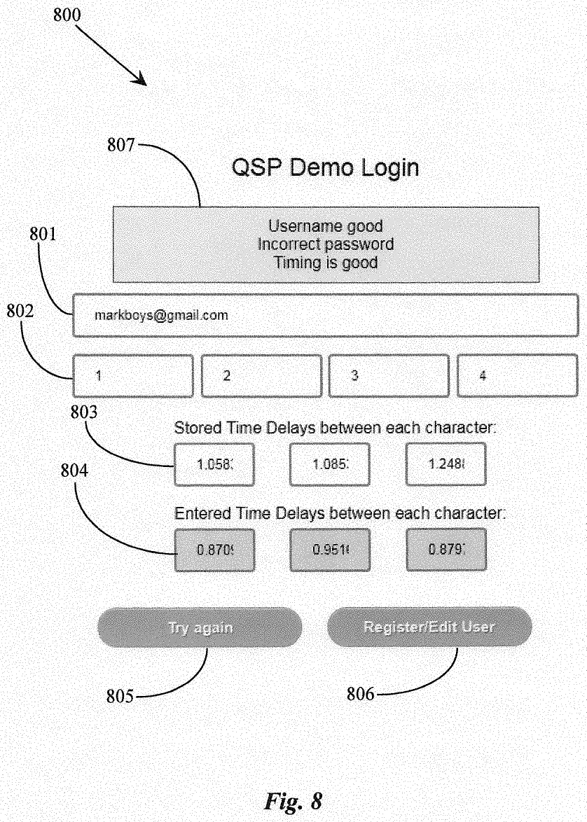

FIG. 8 shows a portion of the operation of creating a password with time delays created in between entering characters of a password. FIG. 8 shows the practice of the user creating time delays in between one or more characters of a password. User enters username in 801. User enters characters of password waiting for a period of time between entering the characters of the password. 803 shows the stored time delay previously entered by the user for his password. 804 indicates that the time delays are close enough for use given a green light. Once the user is happy with the delays he can login to unlock data or enter into website, a document or any other function that requires a password. Window 807 may show the success or lack thereof of the user's attempt at the correct time delays while entering his password. In this attempt the user has success.

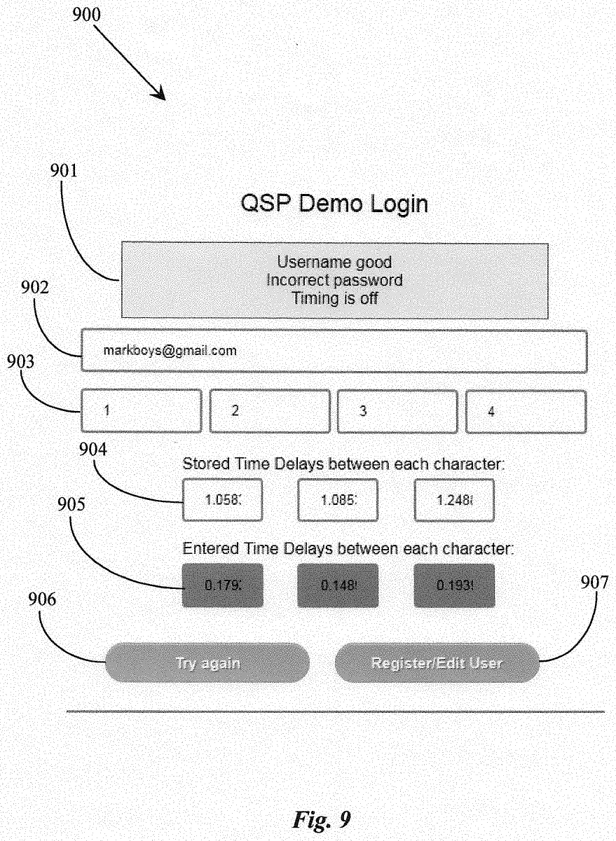

FIG. 9 shows a user's attempt at creating and reentering a password through the password demo 900. In this attempt the user has failed in the attempt to enter the previously stored password with the appropriate time delays between characters. Window 901 indicates the user typed his password too fast, not waiting long enough in between entering the characters of the password.

In summary this invention enables methods for introducing a temporal element into a password to avoid such hacking attempts such as a brute force attack. The time element may be holding one or more keys down for a period of time before, during or after the entry of the characters of a password. The time element may be introduced by holding each key down for a certain period of time or at least a certain amount of time while entering a password. Thresholds or allowable variations may be allowed so that if you are close enough to the time set for the temporal element the system will still allow unlocking.

What is claimed is:

1. A method for securing data via a password wherein a temporal element is introduced into a user's password during password selection.

2. The method of claim 1 wherein a user's password contains one or more alphanumeric characters.

3. The method of claim 1 wherein a user's password contains one or more special characters and/or symbols.

4. The method of claim 1 wherein a user's password contains one or more alphanumeric characters, special characters and/or symbols.

5. The method of claim 1 wherein a user selects a password using one or more alphanumeric characters, special characters and/or symbols, inserts a temporal element between a least two of the characters of a password while entering the password to unlock data.

6. The method of claim 5 wherein a user selects a password using one or more alphanumeric characters, special characters and/or symbols, inserts one or more temporal elements between at least two of the characters of a password wherein the one or more temporal elements become parts of the user's password in the future.

7. The method of claim 5 wherein the temporal element is a set time such as 0.5 seconds.

8. The method of claim 6 wherein the temporal elements are a set time such as 0.5 seconds.

9. Method of claim 6 wherein the temporal element is invoked by holding down at least one key on a keyboard.

10. Method of claim 6 wherein the temporal is invoked by simultaneously holding down one or more keys on a keyboard.

11. The method of claim 10 wherein one or more keys on a keyboard are held down by a user for a specific amount of time inserting a temporal element into a password during the formation of a password and wherein the password retains the inserted temporal elements for future entry of the newly created password.

12. The method of claim 10 wherein once keys are held down for the specified amount of time the password releases data and wherein if the keys are not held down for long enough the password does not function to release data.

13. The Method of claim 12 wherein a notification element alerts a user that one or more temporal elements of a password have been reached when re-entering a password with a temporal element to release data.

14. The method of claim 13 wherein the alert element as a light on a keyboard.

15. The Method of claim 13 wherein a notification element is one of an audio alert, a visual alert or a physical alert.

16. The Method of claim 13 wherein a notification element message is pushed to a smart phone alerting the user that the temporal element has been reached while entering a password containing a temporal element.

17. The Method of claim 13 wherein an example of a physical alert is the vibration of a part of a users computing system.

18. The Method of claim 5 wherein a users temporal password can be created and used on one of a web browser, a web site, an operating system, an app or any program that utilizes passwords to protect data.

19. The method of claim 5 wherein the temporal element is created by a time sensitive touch element implemented by a user on a touch screen.

20. The method of claim 19 wherein the touch element is created by dragging ones finger in a particular direction for a certain amount of time on a touch sensitive screen while entering a temporal element between the characters of a password thereby creating a temporal element into a password.

21. The method of claim 19 wherein the touch element is created by dragging ones finger in a squiggle pattern for a certain amount of time on a touch sensitive screen while entering a temporal element between the characters of a password thereby creating temporal element into a password.

22. Method of claim 6 wherein the temporal is invoked by holding down one or more keys on a keyboard in a sequence wherein each key invokes a temporal element into a password.
